(19) United States
(12) Patent Application Publication
(10) Pub. No.: US 2009/0125316 A1
(43) Pub. Date: May 14, 2009

(54) Rescue container method and apparatus

(76) Inventor: Barrett H. Moore, Winnetka, IL (US)

Correspondence Address: FITCH EVEN TABIN AND FLANNERY, 120 SOUTH LASALLE STREET, SUITE 1600, CHICAGO, IL, 60603-3406, US

(21) Appl. No.: 11/420,594

(22) Filed: May 26, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.

(51) Int. Cl. G06Q 10/00; E04H 14/00; E04B 1/00; G06Q 90/00

(52) U.S. Cl. 705/1; 52/741.1; 52/79.1

(57) ABSTRACT

At least one human-transport rescue container (200) is provided (103) atop a building. This human-transport rescue container comprises, at least in part, interior travel accommodations (201) configured and arranged to safely accommodate at least one person in need of rescue. This human-transport rescue container also comprises, at least in part, a lift-line interface (501). These embodiments then provide for provision (105) of an air vehicle to operably couple to the lift-line interface and thereby effect selective movement of the human-transport rescue container from atop the building to another location to thereby effect a rescue of any persons within the human-transport rescue container. This can further comprise affixing (101) a cradle to the building within which the container can be disposed to retain the container notwithstanding wind shear while nevertheless not substantially preventing intended vertical movement of the container.

### RELATED APPLICATIONS

This application comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277; the contents of which are fully incorporated herein by this reference.

### TECHNICAL FIELD

This invention relates generally to the rescue of persons from a building.

### BACKGROUND

Various events can lead to a need to evacuate a given location. In some cases the event can be highly local and apply, for example, to only a single building. In other cases the event can be more widespread and apply to multiple buildings, an entire municipal area, or further. Particular challenges accompany a need to evacuate a relatively large, and particularly a tall, building. Large buildings can simultaneously accommodate hundreds or even thousands of persons. It is often not possible, however, for the entire working or residential population of a given building to simultaneously, quickly, and safely evacuate that building during a time of need.

Prior art practices in this regard vary with the building but typically include controlled (or excluded) use of elevators and stairways (both internal and external). These avenues of egress are typically highly capacity limited. In many instances, however, a need to evacuate a building can comprise a highly time sensitive need. When time is of the essence, such constrained escape avenues leave much to be desired.

Hover-capable aircraft, such as helicopters, have been used to rescue endangered persons from building rooftops. This technique has been used, for example, to rescue people from the rooftops of flooded homes. This approach, however, also leaves much to be desired in practice. Amongst any number of other deployment problems, the confusion, visibility problems, lack of knowledge regarding useful behaviors on the part of would-be rescuees, lack of sufficient near-term airborne resources and/or passenger capacity, and lack of communication as can characterize a rescue setting when seeking to employ such an approach mitigates heavily against relying upon such tactics.

### BRIEF DESCRIPTION OF THE DRAWINGS

The above needs are at least partially met through provision of the rescue container method and apparatus described in the following detailed description, particularly when studied in conjunction with the drawings, wherein:

FIG. 1 comprises a flow diagram as configured in accordance with various embodiments of the invention;

FIG. 2 comprises a top plan schematic block diagram view as configured in accordance with various embodiments of the invention;

FIG. 3 comprises a perspective schematic view as configured in accordance with various embodiments of the invention;

FIG. 4 comprises a block diagram view as configured in accordance with various embodiments of the invention;

FIG. 5 comprises a perspective schematic view as configured in accordance with various embodiments of the invention;

FIG. 6 comprises a perspective schematic view as configured in accordance with various embodiments of the invention;

FIG. 7 comprises a side elevational schematic view as configured in accordance with various embodiments of the invention;

FIG. 8 comprises a side elevational schematic view as configured in accordance with various embodiments of the invention;

FIG. 9 comprises a side elevational schematic view as configured in accordance with various embodiments of the invention;

FIG. 10 comprises a side elevational schematic view as configured in accordance with various embodiments of the invention; and

FIG. 11 comprises a side elevational schematic view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, at least one human-transport rescue container is provided atop a building (either at a time of need or well prior thereto). This human-transport rescue container comprises, at least in part, interior travel accommodations configured and arranged to safely accommodate at least one person in need of rescue. This human-transport rescue container also comprises, at least in part, a lift-line interface. These embodiments then provide for provision of an air vehicle to operably couple to the lift-line interface and thereby effect selective movement of the human-transport rescue container from atop the building to another location to thereby effect a rescue of any persons within the human-transport rescue container.

By one approach, these actions can further comprise affixing a cradle to the aforementioned building within which the human-transport rescue container can be disposed. By one approach this cradle will tend to retain the human-transport rescue container notwithstanding wind shear while nevertheless not substantially preventing vertical movement of the human-transport rescue container (and hence intended removal of the human-transport rescue container from the building). If desired, the human-transport rescue container can be selectively moved on the building in order to facilitate, for example, optimum placement of the human-transport rescue container during a time of need.

By one approach, consideration-based private civil security subscriptions are accepted from subscribers with respect to gaining access to these rescue resources. In particular, such a subscription can provide rescue services for authorized beneficiaries of the subscription using the air vehicle to come to the human-transport rescue container and move the authorized beneficiaries contained therein away from the building. By one approach these assets are reserved, committed, maintained, and used substantially solely as a rescue response.

These steps are facilitated without dependency upon governmental oversight, participation, or control. The particular rescue capability provided can vary with the needs and requirements of the authorized beneficiaries. Importantly, via these teachings an individual can take important steps to bring a considerably improved measure of security into their lives, knowing that, should a catastrophic event indeed be visited upon a building that they occupy, they are more likely to be successfully rescued and moved, safely and effectively, from that building. Such benefits are possible within necessarily requiring extensive training of the authorized beneficiaries. These teachings also increase the likelihood of being able to successfully carry out such a rescue notwithstanding the limited visibility, confusion, noise, and potentially limited window of opportunity that many event scenarios may present.

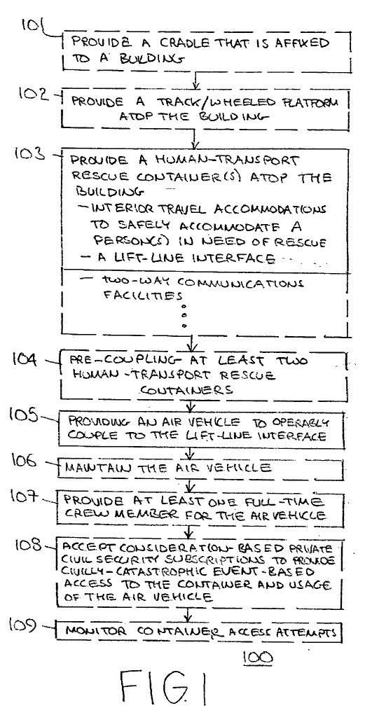

These and other benefits may become clearer upon making a thorough review and study of the following detailed description. Referring now to FIG. 1, these teachings accommodate a process 100 that provides 103, atop a building, a human-transport rescue container. The building may be essentially any presently known or hereafter-developed building including but not limited to residential buildings, commercial buildings, industrial buildings, sports and performance arenas and venues, governmental and other public buildings, and so forth. In a typical (though not required scenario) the building will likely be relatively tall and hence comprise a multi-story structure. The roof of the building may be flat but such a configuration is not required. It is quite possible to employ these teachings, for example, with a building having only inclined roof surfaces.

In general, the building will include a mechanism whereby a person can gain access to the human-transport rescue container. Such mechanisms (including but not limited to doors, stairways, ladders, and so forth) are known in the art and can vary greatly from building to building. Accordingly, no further elaboration regarding such mechanisms need be presented here.

Referring momentarily to FIG. 2, the human-transport rescue container 200 can assume any of a wide variety of shapes and configurations including square-shaped containers, rectangular-shaped containers, cylindrical-shaped containers, spherical-shaped containers, and so forth. Viewed schematically, such a human-transport rescue container 200 will comprise interior travel accommodations 201 that are configured and arranged to safely accommodate at least one person in need of rescue. This can comprise, for example, at least a first seat 202 and up to an Nth seat 203, where N represents, for example, a given number of persons that are to be simultaneously accommodated by the human-transport rescue container during a time of need.

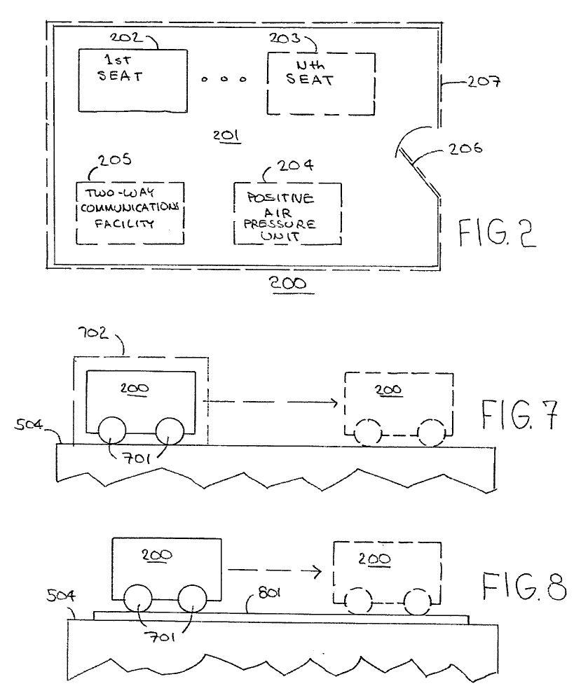

Such a seat can assume any of a wide variety of form factors as are known in the art or that may be hereafter developed. With momentary reference to FIG. 3, such a seat 202 can generally comprise a sitting area as well as a back/head support area if desired. Arm rests (not shown) can also be provided as desired. By one approach this can further comprise providing at least one selective restraint to selectively restrict movement of a seated person. This can comprise, for example, a seat belt 301, a shoulder harness 302, and/or appropriately placed airbags 303 as are known in the art. Other restraint practices may also be used in addition to such restraints or in lieu thereof.

Referring again to FIG. 2, the human-transport rescue container 200 may optionally further comprise a positive air pressure unit 204 to permit the selective establishment of positive air pressure within the interior travel accommodations 201. With momentary reference to FIG. 4, for example, this can comprise an air mover 401 (such as a fan or the like) that forces air into the interior travel accommodations 201. If desired, such forced air movement can be directed through one or more filters 402 to remove possibly harmful airborne contaminants such as, but not limited to, biological and/or chemical agents, radioactive materials, and so forth. As is known in the art, positive air pressure within an enclosed space will aid with preventing airborne noxious agents from entering the enclosed space. This, in turn, can aid in preventing undue exposure to such agents by inhabitants of that enclosed space.

By one approach, and referring again to FIG. 2, the human-transport rescue container 200 can further optionally comprise two-way communications facilities 205. Such facilities 205 can serve, for example, to facilitate communications from within the interior travel accommodations 201 with persons external to the human-transport rescue container 200. Such communications can serve to confirm that rescue is presently required, that all persons to be rescued are now within the human-transport rescue container 200, that all persons within the human-transport rescue container 200 are properly positioned and restrained, and so forth. These two-way communication facilities 205 can comprise wireless and/or non-wireless facilities of choice. As numerous such platforms and techniques are known in the art, and as these present teachings are relatively insensitive to the selection of any particular approach in this regard, further elaboration here will be avoided for the sake of brevity and clarity.

The human-transport rescue container 200 will also typically comprise at least one door 206 or other point of ingress and egress to accommodate the entry and exit of human-transport rescue container passengers. By one approach this point of ingress/egress comprises a sealable point of ingress/egress and hence provides a relatively air-tight seal when closed to thereby further aid with preventing local airborne contaminants from entering the human-transport rescue container 200. This point of ingress/egress may further be provided with a locking mechanism to permit selective control with respect to accessing the human-transport rescue container 200. By one approach, this door 206 is configured and arranged to open inwardly. This, in turn, permits the door 206 to be opened even when, for example, debris or other obstructions are present in the immediate external vicinity of the door 206.

The human-transport rescue container 200 may be comprised of any suitable materials. In general, these materials should provide sufficient strength to accommodate the uses described herein and to provide non-collapsing (during usage) support of the desired number of persons to be rescued. Potentially useful materials include, but are not limited to, steel, aluminum, fiberglass, any of a variety of polymers, and carbon fiber composite materials as are known in the art. Such materials can incorporate, or can be encased by, ionizing radiation shielding 207 such that part, or all, of the human-transport rescue container 200 is so shielded. This can comprise, for example, laminating one or more layers of radiation-blocking fabric, such as Demron as is available through Radiation Shield Technologies, about the human-transport rescue container 200.

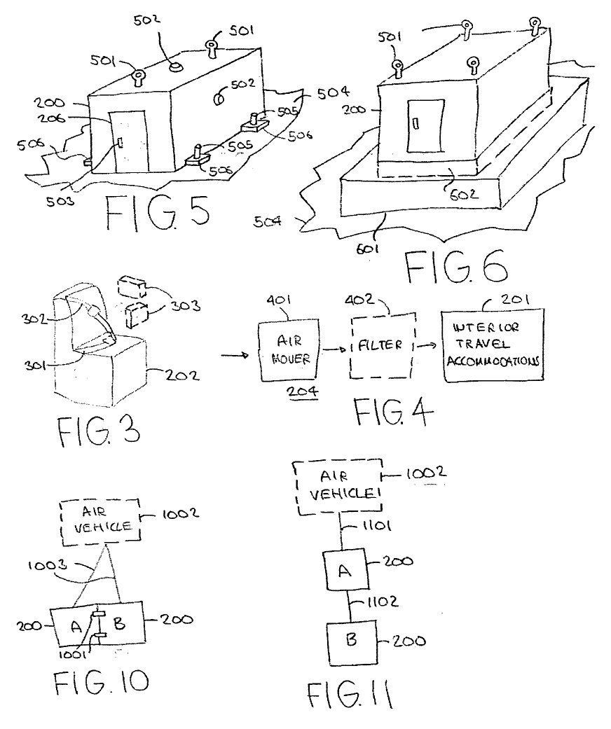

Referring now to FIG. 5, the human-transport rescue container 200 will further typically comprise a lift-line interface 501 such as a hook receptacle such as an eyelet. Only one such interface need be provided, but in a typical scenario it may be expected that control of the human-transport rescue container 200 during airborne movement will be considerably enhanced by providing at least two or more such lift-line interfaces 501. For example, two such lift-line interfaces 501 are shown in FIG. 5 while four such lift-line interfaces 501 are depicted in FIG. 6. All or part of the lift-line interface 501 can comprise a magnetic interface (where, for example, all or part of the lift-line interface 501 comprises a permanent magnet, an electromagnet, and/or ferromagnetic material). Such an approach may facilitate, for example, a rapid mating of the lift-line interface 501 with a lift line during a rescue event.

Various kinds of coupling equipment are known in the art and others will likely be developed in the future. These teachings are generally compatible for use with any or all such approaches. For example, the coupling mechanism comprising the lift-line interface can be remotely operable by, for example, the air vehicle pilot or other personnel, can be manually deployed and placed by trained personnel (such as an air vehicle crew member that descends to the container during a rescue process), and/or can be manually placed and manipulated by a container occupant.

Other embellishments are possible as well. As but one example in this regard, external lighting 502 can be provided on one or more surfaces of the human-transport rescue container 200. Such external lighting 502 can comprise strobe lights, colored lights, and so forth to aid in facilitating a rescue operation. This lighting can serve, for example, to facilitate locating the human-transport rescue container 200 and/or effecting a rapid coupling to the lift-line interfaces when visual conditions are poor due to nighttime operations, smoke, and so forth.

In general, the interior travel accommodations 201 need not be overly plush though creature comforts can be taken into account if so desired. In a typical deployment setting, the human-transport rescue container 200 will not be expected to travel very far in order to complete the rescue operation and hence it may not be necessary to provide longer term survival accoutrements such as sanitary facilities, food and water supplies, and so forth. It may be useful, if desired, to provide at least some medical supplies (such as first aid supplies or private short-term medical needs such as prescriptions for acute conditions or the like), private oxygen masks and supplies, rescue and/or survival-friendly clothing (such as fireproof or fire-resistant clothing, radiation-blocking clothing, and so forth), and so forth.

For at least some application settings, and referring momentarily to FIG. 7, it may be useful or helpful to provide the human-transport rescue container 200 with wheels 701. Such wheels can serve, for example, to facilitate selective movement of the human-transport rescue container 200 about the rooftop surface (or at an eventual drop-off point). For example, the human-transport rescue container 200 might be retained within a corresponding shelter 702 and moved via the wheels 701 to a more preferred position when needed for rescue purposes. (It would also be possible to substitute skids or the like for one or more such wheels. Accordingly, those skilled in the art will recognize and understand that “skid” can be substituted for “wheel” as desired and used herein.)

When such wheels 701 are provided, if desired, the human-transport rescue container 200 may further comprise its own self-locomotion and directional control capability. For example, at least one or more of these wheels 701 can be coupled to a corresponding drive train to effect selective self-controlled movement of the human-transport rescue container 200. Various apparatus and techniques are known in the art in this regard and require no further elaboration here. Such a capability may be useful to facilitate controlled rooftop movement of the human-transport rescue container 200 and/or controlled movement of the human-transport rescue container 200 upon movement of the latter to a location away from the building.

If desired, the human-transport rescue container 200 can be configured and arranged to float in a liquid such as fresh water or salt water bodies. This may be useful when effecting a transfer of such a container to a water-based landing using a nearby convenient body of water. In such a case, it may also be useful to provision the human-transport rescue container 200 with its own self-locomotion capability to facilitate controlled movement of the human-transport rescue container 200 when floating in a body of water.

With continued reference to FIG. 1, this process 100 can also optionally provide for provision 101 of a cradle atop the same building. By one approach this can comprise affixing the cradle to the rooftop (or other appropriate available surface) of the building. A primary purpose of this cradle, when provided, is to receive the human-transport rescue container 200 and to tend to retain the latter notwithstanding such external forces as wind shear. Accordingly, by one approach, this cradle may comprise vertical elements that are positioned to substantially prevent lateral movement of the human-transport rescue container 200 while not substantially preventing intended vertical movement of the human-transport rescue container 200.

Such a cradle can comprise a single integrated structure or can comprise a plurality of disparate elements. For example, as one illustrative approach in this regard (and referring again to FIG. 5), the cradle can be comprised of a plurality of vertically oriented poles 505 that are secured to the building rooftop 504. These vertically oriented poles 505 are positioned in this illustrative embodiment with two such poles 505 on either side of the human-transport rescue container 200. The latter, in turn, further comprises four flanges 506 that are similarly positioned and that extend substantially horizontally away from the walls of the human-transport rescue container 200. In this embodiment each such flange 506 has a hole disposed therethrough of sufficient size to receive one of the vertically oriented poles 505.

For most application settings it is not likely necessary that this comprise an especially snug fit; in fact, in general, a relatively loose fit may be preferred. For example, the poles 505 may have a diameter of about four inches while the holes have a diameter of about, say, five inches. Similarly, it is not especially necessary for at least most application settings that the poles 505 extend a great distance above their corresponding flanges 506. In some settings, for example, it might be possible that the poles 505 do not extend above the flange 506 upper surface at all.

As another illustrative example, and referring again to FIG. 6, the cradle cane comprise an integral block 601 having a recessed area 602 formed therein to receive the human-transport rescue container 200. As before, it may not be necessary for this to comprise a snug fit and may, in fact, serve better as a relatively loose fit. Again, at least one primary purpose to be served by such a cradle is to aid in preventing undesired movement of the human-transport rescue container 200 due to wind shear, collisions with other rooftop items, and so forth. If desired, such a cradle can be at least partially comprised of heat resistant material to thereby aid in preventing the interior travel accommodations of the human-transport rescue container 200 from becoming unsuitable for human habitation due to fire within the building.

Referring again to FIG. 1, this step of providing 101 a cradle can comprise, if desired, provision of a plurality of cradles atop such a building. This, in turn, can support providing a plurality of corresponding human-transport rescue containers atop that building when providing 103 such containers as per the above-described step. Providing multiple human-transport rescue containers 200 will increase the number of persons that can be rescued in this manner. If desired, two or more of these human-transport rescue containers can be pre-coupled to one another as described below in more detail.

This process 100 can also optionally accommodate provision 102 of a track and/or a wheeled platform atop the building. FIG. 8 provides an illustrative schematic representation of a track 801 that is attached to the building rooftop 504 and that supports, in this illustrative embodiment, a human-transport rescue container 200 that has corresponding wheels 701 to operate cooperatively with such a track 801. So configured, the human-transport rescue container 200 can again be selectively moved on the building rooftop 504. In this case, however, movement of the human-transport rescue container 200 is more constrained and cannot, in ordinary course, be diverted from the track 801 itself. This may comprise an important safety consideration for at least some application settings. A track 801 can also serve to assist proper placement of the human-transport rescue container 200 during a time of need as the track 801 will serve as a self-directing guide in this regard.

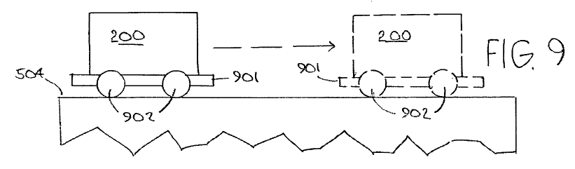

As another approach with respect to effecting wheeled movement of the human-transport rescue container 200 atop a building rooftop, and referring now to FIG. 9, a wheeled platform 901 having corresponding wheels 902 can be provided. This can comprise disposing the human-transport rescue container 200 on the wheeled platform 901 to thereby again facilitate moving the human-transport rescue container 200 into, for example, a preferred location during a time of need. By one approach this wheeled platform 901 can comprise a discrete apparatus with respect to the human-transport rescue container 200 and/or any cradle that may be associated therewith. By another approach the wheeled platform 901 can comprise an integral part of at least one of the human-transport rescue container 200 and a corresponding cradle if desired.

Referring again to FIG. 1, as described earlier the step of providing 103 a human-transport rescue container atop a building can comprise, if desired, providing a plurality of such human-transport rescue containers atop a given building. When such is the case, if desired, this process 100 can further optionally accommodate pre-coupling 104 at least two such human-transport rescue containers. This can comprise, by one approach, pre-coupling these human-transport rescue containers such that they can be air-lifted in a side-by-side configuration. Such a configuration is schematically illustrated in FIG. 10 where a first container A is attached to another container B by corresponding couplers 1001 of choice to thereby permit a single air vehicle 1002 to lift both such containers via corresponding lift lines 1003. By another approach, if desired, this pre-coupling can comprise permitting these coupled human-transport rescue containers to be air-lifted with the containers being disposed one above the other. Such a configuration is schematically illustrated in FIG. 11 where the air vehicle 1002 couples to container A via a first lift line 1101 and this container A connects to container B via a second lift line 1102 such that, again, a single air vehicle is able to lift both containers.

Referring again to FIG. 1, this process 100 then provides for provision 105 of an air vehicle to operably couple to the lift-line interface and thereby selectively move the human-transport rescue container from atop the building to another location to thereby effect a rescue of any persons within the human-transport rescue container. When the human-transport rescue container is nested or otherwise retained with a cradle as described above, this can comprise selectively removing the human-transport rescue container from the cradle to thereby effect the above-described removal of the human-transport rescue container from the building rooftop.

By one approach this air vehicle can comprise a helicopter. Particularly useful examples in this regard would include a CH-53 Sea Stallion style of helicopter, a CH-47 Chinook style of helicopter, the CH-54 Sikorsky style of helicopter (or its successor the S-64 Skycrane helicopter), and/or the Sikorsky CH-53E (S-80) Super Stallion helicopter, though other helicopter models would no doubt be capable of adequate service for at least some application settings. Other air vehicles might also be useful in this setting, such as a jet-powered vertical-take-off/landing vehicle, a lighter-than-air craft, and so forth. In general, for many likely application settings, a helicopter, tilt-rotor aircraft, or heavy lift dirigible will probably represent a preferred vehicle of choice.

In many cases it may be helpful to pre-position the air vehicle relatively proximal to the building rooftop. Such a position may aid with facilitating a timely rescue during a time of need. Such proximity may be measured, for example, by distance and/or by a period of time as may reasonably be required to traverse the distance to the building. For some purposes, for example, it may be appropriate to position the air vehicle within five minutes of flight time to the target building.

At least some civilly-catastrophic events that prompt a need for rescue as per these teachings may be accompanied by an electromagnetic pulse. Such a pulse can permanently damage many electrical circuits including, for example, the electronic engine controls for a vehicle. With this in mind, it may be desirable to harden at least the critical vulnerable systems of the air vehicle to thereby substantially protect those systems against an electromagnetic pulse. Again, various ways and means of achieving such a result are known in the art and may be practiced here as desired.

The purpose of pre-positioning the air vehicle is to ensure its availability during a time of great need. Unfortunately, such a time may be characterized by significant temporary or permanent problems with the infrastructure of modern life. As a result, various significant mission-threatening problems can arise when seeking to use the air vehicle to effect a rescue. As a result, it may be desirable to further outfit the air vehicle in various other ways to better improve the prospects of the air vehicle being able to successfully carry out its rescue mission.

This can comprise pre-supplying the air vehicle with any of a variety of material that is designed to facilitate at least one of improving survivability of the passengers, improving the likelihood that the vehicle can complete its designated travel, and so forth. Examples in this regard include, but are certainly not limited to

body armor (designed to stop at least low caliber small arms fire and of a sturdier variety if desired, including both bulletproof windows, louvered view ports, and armored passenger compartments and/or vehicle compartments);

radiation shielding;

biological/chemical agent protection (including but not limited to the aforementioned positive air pressure capability, decontamination facilities, sealed compartments, and so forth);

medical supplies (including but not limited to first aid supplies as well as first responder emergency medical services supplies such as blood, plasma, automatic external defibrillators, radiation exposure treatments, chemical exposure treatments, antibiotics (including but not limited to medicines such a Tamaflu and the like), and so forth);

spare vehicle parts (including but not limited to mission critical parts relating to the vehicle's drive train, propulsion system, trajectory controls, and so forth);

vehicular maintenance tools;

supplemental vehicular fuel supplies (carried in on-board auxiliary fuel tanks and/or non-integral fuel containers of choice).

This step can comprise pre-positioning more than one air vehicle. In many cases it will be desirable to pre-position at least two such vehicles though many more may be appropriate in some settings to provide increased rescue capability, redundant back-up resources, and so forth.

This process 100 also optionally accommodates maintaining 106 the air vehicle in a substantially constant state of readiness. This can comprise, in part, optionally maintaining and storing the air vehicle in a substantially sheltered area. This substantially sheltered area can be configured to house a plurality of such air vehicles if desired. By one approach the substantially sheltered area may comprise a substantially covered area that essentially comprises only a roof. By another approach the substantially sheltered area may also comprise one or more walls as well to further aid in protecting the vehicle(s) from the elements, unauthorized access, prying eyes, and so forth. By yet another approach the substantially sheltered area can comprise one or more walls disposed around the air vehicle (for example, earthen and/or concrete works formed in a U shape can be employed in this manner) that lack a roof or other overhead cover.

This step of maintaining 106 the air vehicle can also comprise one or more maintenance activities such as, but not limited to:

conducting vehicle maintenance;

providing a supplemental supply of fuel in relatively close proximity to the air vehicle, which supplemental supply of fuel is dedicated to use with the air vehicle(s) at the predetermined location;

providing a store of spare parts for the air vehicle at the predetermined location;

test-driving the air vehicle from time to time (for example, on a scheduled basis and/or an un-scheduled basis); and

test-operating the air vehicle from time to time.

This process 100 also optionally comprises providing 107 at least one full-time crew member for the air vehicle. By one approach this can comprise providing crew member quarters closely proximal to the air vehicle such that the at least one full-time crew member is available to facilitate substantially immediate initiation of a rescue effort. The duties of such personnel can and will vary with the specific kind of vehicle and also with the specifics of any particular rescue task(s). Exemplary duties comprise, monitoring for the need to effect a rescue, piloting the air vehicle, co-piloting the air vehicle, navigating the air vehicle, conducting two-way wireless communications during a rescue effort, managing or otherwise overcoming mission obstacles, coupling one or more lift lines to one or more human-transport rescue containers, and so forth.

This step of providing at least one full-time crew member can optionally accommodate maintaining the rescue service personnel in a substantially constant state of readiness. This can comprise, for example, conducting test drills with such personnel and/or with the intended passengers. Such drills can comprise, for examples, drills to practice communicating with or otherwise making contact with intended passengers, operating the air vehicle, identifying and controlling or overcoming any of a variety of potentially mission-impairing obstacles, and performing and/or experiencing other circumstances or events of possible relevance or interest. Such drills may also entail, if desired, simulated and/or replicated rescue conditions that may pose a particular challenge if encountered during a non-drill rescue mission.

These teachings can further optionally provide for accepting 107 consideration-based private civil security subscriptions from subscribers with respect to providing rescue services by which the aforementioned vehicle(s) and personnel come to the corresponding human-transport rescue containers and move the authorized beneficiaries of such subscriptions away from the corresponding building. By one approach, these rescue resources are reserved, committed, maintained, and used substantially solely as a rescue response to a civilly-catastrophic event. So configured, an authorized beneficiary would use, for example, standard 911 resources when dealing with everyday problems involving safety, health, fire, crime, and so forth. By another approach, if desired, these rescue resources could be employed at any time that a rescue from the building in question appears as an appropriate action to take.

This right of rescue can pertain, if desired, to a predetermined timeframe. For example, a given subscription can relate to providing rescue as may be required during a given one year period for one or more authorized beneficiaries as are covered by a given subscription. By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of rescue (as where a subscription provides rescue rights for a specific period of time, such as one year, in exchange for a corresponding series of payments);

event-limited rights of rescue (as where a subscription provides rescue rights during the life of a given subscriber based upon an up-front payment in full and where those rescue rights terminate upon the death of the subscriber or where, for example, a company purchases a subscription for a key employee and those corresponding rights of rescue terminate when and if that key employee leaves the employment of that company);

inheritable rights of rescue (as may occur when the subscription, by its own terms and conditions, provides a right of rescue that extends past the death of a named subscription beneficiary and further allows for testate and/or intestate transfer to an heir);

rights of rescue predicated upon a series of periodic payments (as where a subscription provides rescue rights during, for example, predetermined periods of time on a periodic basis as where a subscriber offers month-by-month payments to gain corresponding month-by-month rescue rights);

rights of rescue predicated upon a one-time payment (as may occur, when a subscriber makes a single payment to obtain a time-based or event-based duration of rescue rights or, if desired, when a single payment serves to acquire a perpetual right of rescue that may be retained, transferred, inherited, or the like);

ownership-based rights of rescue (as may occur when the subscription provides for ownership rights regarding rescue);

non-transferable rights of rescue (as may occur when the subscription, by its terms and conditions, prohibits transfer of the right of rescue from a first named beneficiary to another);

transferable rights of rescue (as may occur when the subscription, by its terms and conditions, permits conditional or unconditional transfer of the right of rescue from a first named beneficiary to another);

membership-based rights of rescue (as may occur when the subscription, by its terms and conditions, establishes a membership interest with respect to the accorded right of rescue such as, for example, a club-based membership);

fractionally-based rights of rescue (as may occur when the subscription, by its terms and conditions, establishes a divided or undivided co-ownership interest by and between multiple subscription beneficiaries with respect to a right of rescue, the human-transport rescue container itself, and so forth); and/or

non-ownership-based rights of rescue (as may occur when the subscription, by its terms and conditions, establishes the aforementioned right of rescue via, for example, a lease, rental, or borrowing construct).

By a somewhat different approach, a building owner or tenant could provide the human-transport rescue container(s) atop their building along with the corresponding rescue service and then offer space in the container on a marked-up basis to building occupants. This could be done on a sales basis, a leased basis, and so forth. The pricing for such opportunities could be fixed or variable as desired. For example, a bidding approach could serve to set pricing for at least some seats if desired. As another example one or more such seats could be bundled with other properties within the building. As one illustration in this regard, rental of a given floor in the building could automatically include places for four persons to be named within such a human-transport rescue container atop that building.

If desired, a plurality of differentiated subscription opportunities can be offered in this regard. This plurality of differentiated subscription opportunities can correspond, for example, to providing access to differing transport modalities, transport accommodations, predetermined locations, and so forth. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing rescue services that are economically selected while another subscription might provide for rescue services that are more costly and in turn reflect, for example, a wider variety of choices with respect to rescue modality and/or maximum time of response, accommodations, creature comforts, and so forth.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted above, if desired, these subscriptions can relate to providing rescue in the event of a civilly-catastrophic event. Such transport may be predicated, if desired, upon a requirement that the civilly-catastrophic event be one that will likely persist in substantial form for more than a predetermined period of time (such as one hour, one day, one week, and so forth) or that causes at least a predetermined amount or degree of civil infrastructure impairment or other measurable impact of choice.

As used herein, “civilly-catastrophic event” will be understood to refer to an event that substantially and materially disrupts a society's local, regional, and/or national infrastructure and ability to provide in ordinary course for the at least one medical service that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well as acts of war, terrorism, madness or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

As one option, if desired, this process 100 can further accommodate accepting what amounts to a secondary subscription for secondary rescue rights. By this approach, less expensive subscriptions can be provided for rescue if and when a first tier of primary authorized beneficiaries are successfully rescued. This might comprise, for example, a return of the air vehicle to a particular building to remove additional containers. As another example, this might comprise a visit of the air vehicle to a particular building (either as a first visit or as a return visit) while bearing at least one human-transport rescue container which can then be lowered to the building rooftop to recover additional passengers. By one approach, if desired, the primary subscribers could share in the consideration offered by such secondary subscribers.

These teachings can also optionally provide for monitoring 109 the human-transport rescue container(s) to detect when a person at least attempts to access the interior travel accommodations. Such monitoring can serve, for example, to detect when unauthorized access is being attempted and/or to detect when a need for rescue presently exists. By one approach, this monitoring can comprise, at least in part, use of the aforementioned two-way communications facilities to permit communications with persons to be rescued within the interior travel accommodations. By other approaches, this monitoring can be based, at least in part, on other visual, audio, telephonic, or wireless-based signals that suggest or confirm occupancy of the container. If desired this monitoring can be configured and arranged to permit or facilitate determination of the number of occupants, the percent of overall utilized volume, and/or present occupancy weight. Weight, for example, can be important to understand as the air vehicle will typically have an upper limit to its lift capacity. Such information could be used, for example, to detect when too many passengers have entered the container and/or when undue non-passenger cargo (such as files, personal possession, or the like) has been brought aboard.

If desired, this process 100 can also provide for confirming that a given would-be passenger is authorized to make use of the aforementioned resources. This may comprise, if desired, use of a mechanism that the authorized beneficiary carries with them to confirm their authorized status in this regard. This mechanism can comprise personal property (such as an identification card) or can comprise, for example, a biometric-based identity authentication process that relies upon fingerprints, retinal patterns, or some other relatively unique aspect of the human body.

It will be appreciated that these teachings provide for a highly flexible yet powerfully effective way by which a modern citizen can greatly improve their likelihood of being rescued from a building, including a very tall building, during a time of great need, confusion, and danger and when time is of the essence. These teachings are sufficiently flexible so as to accommodate the needs and desires of a wide-ranging set of potential beneficiaries.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, by one optional approach, the human-transport rescue container can comprise a collapsible structure. By this approach, the human-transport rescue container can be stored in a compressed state (such as, but not limited to, a horizontally collapsed state, a vertically collapsed state, an at least partially non-inflated state, and so forth). This would permit a greater number of human-transport rescue containers to be stored conveniently atop a given building rooftop. Various collapsible structures are known in the art that would suffice in this regard including, but not limited to, a rapidly inflatable structure that could be stored in an non-inflated state and then quickly inflated during a time of need.

As another example in this regard, the human-transport rescue container may itself possess the means to effect its own airborne removal from the building. By one approach the container can further comprise self-deploying helium-filled lift balloons in sufficient size and number to permit the container to rise from the building rooftop.

I claim:

1. A method comprising:
providing, atop a building:
a cradle that is affixed to the building;
a human-transport rescue container that is nested within the cradle such that the human-transport rescue container will tend to stay retained within the cradle notwithstanding wind shear, wherein the human-transport rescue container comprises:
interior travel accommodations configured and arranged to safely accommodate at least one person in need of rescue;
a lift-line interface;
providing an air vehicle to operably couple to the lift-line interface and thereby selectively remove the human-transport rescue container from the cradle and move the human-transport rescue container from atop the building to another location to thereby effect a rescue of any persons within the human-transport rescue container.

2. The method of claim 1 wherein the cradle comprises vertical elements that are positioned to substantially prevent lateral movement of the human-transport rescue container.

3. The method of claim 2 wherein the vertical elements are further configured and arranged to not substantially prevent horizontal movement of the human-transport rescue container.

4. The method of claim 1 wherein the human-transport rescue container further comprises a point of ingress and egress to accommodate human-transport rescue container passengers.

5. The method of claim 4 wherein the point of ingress and egress comprises a sealable point of ingress and egress.

6. The method of claim 5 wherein the sealable point of ingress and egress comprises a locking mechanism such that access to the interior travel accommodations is selectively controllable.

7. The method of claim 5 wherein the sealable point of ingress and egress comprises a door that opens inwardly.

8. The method of claim 1 wherein the interior travel accommodations comprise, at least in part, a seat.

9. The method of claim 1 wherein the interior travel accommodations comprise, at least in part, at least one selective restraint to selectively restrict movement of a human-transport rescue container passenger.

10. The method of claim 9 wherein the at least one selective restraint comprises at least one of:
a seat belt;
a shoulder harness;
an airbag.

11. The method of claim 1 wherein the interior travel accommodations further comprise means for selectively establishing positive air pressure within the interior travel accommodations.

12. The method of claim 1 wherein the lift-line interface comprises at least one of:
at least one hook receptacle;
at least one eyelet.

13. The method of claim 1 wherein the lift-line interface comprises, at least in part, a magnetic interface.

14. The method of claim 1 wherein providing, atop a building, a cradle that is affixed to the building and a human-transport rescue container that is nested within the cradle further comprises providing a plurality of the cradles atop the building and at least one of the human-transport rescue containers within each of the cradles.

15. The method of claim 14 further comprising:
pre-coupling at least two of the human-transport rescue containers such that the air vehicle can simultaneously carry the at least two human-transport rescue containers.

16. The method of claim 15 wherein pre-coupling at least two of the human-transport rescue containers such that the air vehicle can simultaneously carry the at least two human-transport rescue containers comprises pre-coupling at least two of the human-transport rescue containers such that the air vehicle can simultaneously carry the at least two human-transport rescue containers with one of the at least two human-transport rescue containers being disposed above the other.

17. The method of claim 15 wherein pre-coupling at least two of the human-transport rescue containers such that the air vehicle can simultaneously carry the at least two human-transport rescue containers comprises pre-coupling at least two of the human-transport rescue containers such that the air vehicle can simultaneously carry the at least two human-transport rescue containers with one of the at least two human-transport rescue containers being disposed substantially side by side.

18. The method of claim 1 wherein the air vehicle comprises at least one of:
a helicopter;
a tilt-rotor aircraft;
a dirigible.

19. The method of claim 1 wherein the cradle is comprised, at least in part, of heat resistant material to thereby aid in preventing the interior travel accommodations from becoming unsuitable for human habitation.

20. The method of claim 1 further comprising:
monitoring the human-transport rescue container to detect when a person at least attempts to access the interior travel accommodations.

21. The method of claim 1 further comprising:
provisioning the human-transport rescue container with two-way communications facilities;
using the two-way communications facilities to communicate with persons to be rescued within the interior travel accommodations.

22. The method of claim 1 wherein the human-transport rescue container further comprises, at least in part, ionizing radiation shielding.

23. The method of claim 22 wherein the ionizing radiation shielding comprises, at least in part, a radiation-blocking fabric disposed about at least a substantial portion of the human-transport rescue container.

24. The method of claim 1 wherein the human-transport rescue container has no wheels to facilitate its movement on a surface.

25. The method of claim 1 wherein the human-transport rescue container has wheels to facilitate its movement on a surface.

26. The method of claim 25 wherein the human-transport rescue container further comprises means for providing self-locomotion on the surface.

27. The method of claim 1 wherein the human-transport rescue container is configured and arranged to float in a liquid.

28. The method of claim 27 wherein the human-transport rescue container further comprises means for providing self-location in the liquid.

29. The method of claim 1 wherein the human-transport rescue container further comprises external lighting to facilitate a rescue operation that comprises moving the human-transport rescue container from the building.

30. The method of claim 1 further comprising:
accepting consideration-based private civil security subscriptions from subscribers with respect to providing civilly-catastrophic event-based access to the human-transport rescue container and corresponding usage of the air vehicle to remove the human-transport rescue container from the building.

31. The method of claim 30 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access.

32. The method of claim 1 wherein providing an air vehicle comprises providing a plurality of air vehicles.

33. The method of claim 1 wherein providing an air vehicle comprises pre-positioning the air vehicle in relative proximity to the building.

34. The method of claim 33 wherein pre-positioning the air vehicle in relative proximity to the building comprises pre-positioning the air vehicle within five minutes of flight time of the building.

35. The method of claim 1 further comprising maintaining the air vehicle.

36. The method of claim 35 wherein maintaining the air vehicle comprises at least one of:
conducting vehicle maintenance;
providing a supplemental supply of fuel in relatively close proximity to the air vehicle, which supplemental supply of fuel is dedicated to use with the air vehicle;
providing a store of spare parts for the air vehicle in relatively close proximity to the air vehicle;
test-driving the air vehicle from time to time;
test-operating the air vehicle from time to time.

37. The method of claim 1 further comprising:
providing at least one full-time crew member for the air vehicle.

38. The method of claim 37 wherein providing at least one full-time crew member for the air vehicle further comprises pre-positioning the at least one full-time crew member closely proximal to the air vehicle such that the at least one full-time crew member is available to facilitate substantially immediate operation of the air vehicle in response to a civilly-catastrophic event.

39. The method of claim 1 further comprising:
providing, atop the building, a track;
disposing the human-transport rescue container on the track to thereby facilitate moving the human-transport rescue container into a preferred location at which to couple with the air vehicle.

40. The method of claim 1 further comprising:
providing, atop the building, a wheeled platform;
disposing the human-transport rescue container on the wheeled platform to thereby facilitate moving the human-transport rescue container into a preferred location at which to couple with the air vehicle.

41. The method of claim 40 wherein the wheeled platform is disposed integral to at least one of the cradle and the human-transport rescue container.

42. The method of claim 40 wherein the wheeled platform comprises a discrete apparatus with respect to both the cradle and the human-transport rescue container.

43. An apparatus comprising:
a building rooftop cradle;
a human-transport rescue container that is nested within the cradle such that the human-transport rescue container will tend to stay retained within the cradle notwithstanding wind shear, wherein the human-transport rescue container comprises:
interior travel accommodations configured and arranged to safely accommodate at least one person in need of rescue;
a lift-line interface configured and arranged to connect to an air-borne lift line to thereby facilitate selectively vertically removing the human-transport rescue container from the cradle and moving the human-transport rescue container from atop a building to another location to thereby effect a rescue of any persons within the human-transport rescue container.

44. The apparatus of claim 43 wherein the cradle comprises vertical elements that are positioned to substantially prevent lateral movement of the human-transport rescue container.

45. The apparatus of claim 44 wherein the vertical elements are further configured and arranged to not substantially prevent horizontal movement of the human-transport rescue container.

46. The apparatus of claim 43 wherein the human-transport rescue container further comprises a sealable point of ingress and egress to accommodate human-transport rescue container passengers.

47. The apparatus of claim 46 wherein the sealable point of ingress and egress comprises a locking mechanism such that access to the interior travel accommodations is selectively controllable.

48. The apparatus of claim 47 wherein the sealable point of ingress and egress comprises a door that opens inwardly.

49. The apparatus of claim 43 wherein the interior travel accommodations comprise, at least in part, a seat.

50. The apparatus of claim 43 wherein the interior travel accommodations comprise, at least in part, at least one selective restraint to selectively restrict movement of a human-transport rescue container passenger.

51. The apparatus of claim 50 wherein the at least one selective restraint comprises at least one of:
a seat belt;
a shoulder harness;
an airbag.

52. The apparatus of claim 43 wherein the interior travel accommodations further comprise means for selectively establishing positive air pressure within the interior travel accommodations.

53. The apparatus of claim 43 wherein the lift-line interface comprises at least one of:
at least one hook receptacle;
at least one eyelet.

54. The apparatus of claim 43 further comprising:
means for pre-coupling a second one human-transport rescue container such that the air vehicle can simultaneously carry at least two human-transport rescue containers.

55. The apparatus of claim 43 wherein the cradle is comprised, at least in part, of heat resistant material to thereby aid in preventing the interior travel accommodations from becoming unsuitable for human habitation.

56. The apparatus of claim 43 wherein the human-transport rescue container further comprises two-way communications facilities to facilitate communications from with the interior travel accommodations with persons external to the human-transport rescue container.

57. The apparatus of claim 43 wherein the human-transport rescue container further comprises, at least in part, ionizing radiation shielding.

58. The apparatus of claim 43 wherein the ionizing radiation shielding comprises, at least in part, a radiation-blocking fabric disposed about at least a substantial portion of the human-transport rescue container.

59. The apparatus of claim 43 wherein the human-transport rescue container has no wheels to facilitate its movement on a surface.

60. The apparatus of claim 43 wherein the human-transport rescue container has wheels to facilitate its movement on a surface.

61. The apparatus of claim 43 wherein the human-transport rescue container further comprises external lighting to facilitate a rescue operation that comprises moving the human-transport rescue container from the building.

62. A method comprising:
providing, atop a building:
at least one human-transport rescue container comprising:
interior travel accommodations configured and arranged to safely accommodate at least one person in need of rescue;
a lift-line interface;
providing an air vehicle to operably couple to the lift-line interface and thereby selectively move the human-transport rescue container from atop the building to another location to thereby effect a rescue of any persons within the human-transport rescue container.

63. The method of claim 62 further comprising:
providing a cradle that is affixed to the building;
disposing the human-transport rescue container within the cradle such that the human-transport rescue container will tend to stay retained within the cradle notwithstanding wind shear.

64. The method of claim 62 wherein the cradle comprises vertical elements that are positioned to substantially prevent lateral movement of the human-transport rescue container.

65. The method of claim 64 wherein the vertical elements are further configured and arranged to not substantially prevent horizontal movement of the human-transport rescue container.

66. The method of claim 62 wherein providing atop a building the at least one human-transport rescue container comprises providing the at least one human-transport rescue container in a compressed state.

67. The method of claim 66 wherein providing the at least one human-transport rescue container in a compressed state comprises providing the at least one human-transport rescue container in at least one of a:
horizontally collapsed state;
vertically collapsed state;
at least partially non-inflated state.

68. The method of claim 66 wherein providing the at least one human-transport rescue container in a compressed state comprises simultaneously providing atop the building a plurality of the human-transport rescue containers.

69. The method of claim 68 wherein simultaneously providing atop the building a plurality of the human-transport rescue containers comprises storing at least some of the plurality of human-transport rescue containers in at least one of:
a stacked configuration;
a horizontally-ordered configuration.
